(19) United States
(12) Patent Application Publication
(10) Pub. No.: US 2026/0084056 A1
(43) Pub. Date: Mar. 26, 2026

(54) ELECTRONIC DEVICE, METHOD, AND COMPUTER-READABLE STORAGE MEDIUM FOR PROVIDING 3-DIMENSIONAL MAP INFORMATION

(71) Applicant: NCSOFT Corporation, Seoul (KR)

(72) Inventors: Boyun KANG, Seongnam-si (KR); Kyeongdae KIM, Seongnam-si (KR); Munsu KIM, Seongnam-si (KR); Taeeun KIM, Seongnam-si (KR); Junghyun LEE, Seongnam-si (KR); Joowon LEE, Seongnam-si (KR); Sunggoo HEO, Seongnam-si (KR)

(73) Assignee: NCSOFT Corporation, Seoul (KR)

(21) Appl. No.: 19/407,353

(22) Filed: Dec. 3, 2025

Related U.S. Application Data
(63) Continuation of application No. PCT/KR2023/014326, filed on Sep. 20, 2023.

(51) Int. Cl. A63F 13/5378; A63F 13/525; A63F 13/5372; G06F 3/04815; G06F 3/04817; G06F 3/0482; G06F 3/0485; G06F 3/0486

(52) U.S. Cl. CPC A63F 13/5378; A63F 13/525; A63F 13/5372; G06F 3/04815; G06F 3/04817; G06F 3/0482; G06F 3/0485; G06F 3/0486

(57) ABSTRACT

An electronic device includes a display, memory, and processor configured to display a screen with a virtual space and a mini-map representing the virtual space, including a player character (PC); display the mini-map in a first state showing a first part of the virtual space from a first viewpoint above the PC along a first direction parallel to an elevation direction; and display, based on an input for changing the viewpoint, the mini-map in a second state showing a second part of the virtual space from a second viewpoint along a second direction different from the first direction. The mini-map includes visual objects indicating the PC's reference location and associated objects displayed in a floated state. The device provides altitude indicators, density representations via slider bars, and interactive UI elements for viewpoint manipulation.

### CROSS-REFERENCE TO RELATED APPLICATIONS

This application is a by-pass continuation application of International Application No. PCT/KR2023/014326, filed on Sep. 20, 2023.

### FIELD

Embodiments disclosed in the present disclosure relate to an electronic device, a method, and a computer-readable storage medium for providing 3-dimensional map information.

### BACKGROUND

An electronic device may provide a virtual space including a character corresponding to a user. For example, the character may include a player character (PC). For example, the virtual space may be displayed through a display of the electronic device.

### SUMMARY

According to an aspect of the disclosure, an electronic device includes a display; at least one memory configured to store at least one program; at least one processor configured to operate as instructed by the program, the program being configured to cause the at least one processor to display, on the display, a screen including at least a part of a virtual space and a mini-map for representing the virtual space, wherein the screen includes a player character (PC) corresponding to a user; display the mini-map in a first state showing a first part of the virtual space as viewed from a first viewpoint above the PC along a first direction parallel to an elevation direction of the virtual space; and display, based on an input for changing a viewpoint of the mini-map, the mini-map in a second state showing a second part of the virtual space as viewed from a second viewpoint along a second direction different from the first direction.

The electronic device may include wherein the mini-map includes a first visual object indicating at least one reference location of the PC in the virtual space, at least one second visual object indicating at least one object associated with the PC, and an image of an area of the virtual space; wherein the at least one first visual object and the at least one second visual object are displayed in a floated state with respect to the image; and wherein the area includes the first part and the second part of the virtual space.

The electronic device may include wherein, based on the at least one object associated with the PC, including an object located at an altitude different from a reference range, the mini-map displays an indicator with a second visual object corresponding to the object located at the altitude different from the reference range; wherein the indicator indicates that the object is located at the altitude different from the reference range; and wherein the reference range represents a spatial range extending from the reference location along the elevation direction.

The electronic device may include wherein the screen, based on the second state of the mini-map, further includes an indicating bar representing a relative altitude of at least one object corresponding to the at least one second visual object; and at least one third visual object including information associated with the at least one object.

The electronic device may include wherein the mini-map comprises a first area, a second area, and a third area between the first area and the second area; wherein the program is further configured to cause the at least one processor to receive an input on the mini-map; highlight visually, based on the input in the first area, a third visual object corresponding to a first object located at an altitude higher than a reference range from among a plurality of objects; highlight visually, based on the input in the second area, a third visual object corresponding to a second object located at an altitude lower than the reference range; and highlight visually, based on the input in the third area, a third visual object corresponding to a third object located at an altitude in the reference range.

The electronic device may include wherein the indicating bar includes a first icon associated with the first object; a second icon associated with the second object; and a third icon associated with the third object, and wherein the program is further configured to cause the at least one processor to based on the third visual object corresponding to the first object, activate the first icon; based on the third visual object corresponding to the second object, activate the second icon; and based on the third visual object corresponding to the third object, activate the third icon.

The electronic device may include wherein the mini-map includes at least one first visual object indicating a reference location in the virtual space of the PC, at least one second visual object indicating at least one object associated with the PC, and an image of a display area of the virtual space identified based on the reference location; and wherein the screen, based on the second state of the mini-map, further includes a slider bar representing a density of the at least one object.

The electronic device may include wherein the program is further configured to cause the at least one processor to display, based on the density for a first altitude having a first density, a first segment of the slider bar corresponding to the first altitude with a first brightness; and display, based on the density for a second altitude having a second density higher than the first density, a second segment of the slider bar corresponding to the second altitude with a second brightness brighter than the first brightness.

The electronic device may include wherein the screen, in the second state of the mini-map, further includes a scroll view displaying information on an object in accordance with an altitude; wherein the scroll view is displayed adjacent to the slider bar, and wherein the program is further configured to cause the at least one processor to detect a swipe input from the second segment toward the first segment; and change sequentially, based on the swipe input, from displaying information on at least one object located at the second altitude to the information on at least one object located at the first altitude.

The electronic device may include wherein the processor is configured to based on detecting release of the swipe input, display the scroll view including a list of the at least one object located at the first altitude; and change, based on a scroll input on the scroll view, information of the at least one object included in the list.

The electronic device may include wherein the screen further includes a ball-shaped user interface (UI) located adjacent to the mini-map, wherein the input includes a drag input on the UI, and wherein the program is further configured to cause the at least one processor to detect a direction of the drag input obtained based on the mini-map in the first state being displayed; based on a first drag direction, change the view point from the first view point to the second view point; and based on the second view point, change an area of the virtual space displayed on the mini-map from the first part to the second part.

The electronic device may include wherein the program is further configured to cause the at least one processor to identify, based on the drag input facing the first drag direction, an angle at which the UI rotates; identify, based on the angle of a first value, the second view point changed by a first elevation angle from the first view point; and identify, based on the angle of a second value greater than the first value, the second view point changed by a second elevation angle greater than the first elevation angle from the first view point.

The electronic device may include wherein the input includes a drag input on the mini-map.

The electronic device may include wherein the first part represents a two-dimensional plane of the virtual space facing the elevation direction; and wherein, based on the second direction being perpendicular to the first direction, the second part represents a two-dimensional plane of the virtual space parallel to the elevation direction.

The electronic device may include wherein the program is further configured to cause the at least one processor to based on receiving a pinch-out gesture, display the screen including the mini-map zoomed in, or based on receiving a pinch-in gesture, display the screen including the mini-map zoomed out.

According to another aspect of the disclosure, a method executed by an electronic device includes displaying, on the at least one display, a screen including at least a part of a virtual space and a mini-map for representing the virtual space, wherein the screen includes a player character (PC) corresponding to a user; displaying the mini-map in a first state showing a first part of the virtual space as viewed from a first viewpoint above the PC along a first direction parallel to an elevation direction of the virtual space; and displaying, based on an input for changing a viewpoint of the mini-map, the mini-map in a second state showing a second part of the virtual space as viewed from a second viewpoint along a second direction different from the first direction.

The method may include wherein the mini-map comprises at least one first visual object indicating at least one reference location of the PC in the virtual space, at least one second visual object indicating at least one object associated with the PC, and an image of an area of the virtual space; wherein the at least one first visual object and the at least one second visual object are displayed in a floated state with respect to the image; and wherein the area includes the first part and the second part of the virtual space.

The electronic device may include based on the at least one object associated with the PC including an object located at an altitude different from a reference range, the mini-map displays an indicator with a second visual object corresponding to the object located at the altitude different from the reference range; wherein the indicator indicates that the object is located at the altitude different from the reference range; and wherein the reference range represents a spatial range extending from the reference location along the elevation direction.

The electronic device may include wherein the screen, based on the second state of the mini-map, further includes an indicating bar representing a relative altitude of at least one object corresponding to the at least one second visual object; and at least one third visual object including information associated with the at least one object.

According to another aspect of the disclosure, a computer-readable storage medium storing at least one programs, wherein the at least one programs comprise instructions which, when executed by a processor of an electronic device, cause the electronic device to display, on the at least one display, a screen including at least a part of a virtual space and a mini-map for representing the virtual space, wherein the screen includes a player character (PC) corresponding to a user; display the mini-map in a first state showing a first part of the virtual space as viewed from a first viewpoint above the PC along a first direction parallel to an elevation direction of the virtual space; and display, based on an input for changing a viewpoint of the mini-map, the mini-map in a second state showing a second part of the virtual space as viewed from a second viewpoint along a second direction different from the first direction.

### BRIEF DESCRIPTION OF THE DRAWINGS

To describe technical solutions of embodiments of this application or related technologies more clearly, the following briefly introduces the accompanying drawings required for describing embodiments or related technologies. Clearly, the accompanying drawings in the following descriptions show only some embodiments of this application, and a person of ordinary skill in the art may still derive other drawings based on these accompanying drawings without creative efforts.

FIG. 1 is an exemplary block diagram of an electronic device in a network environment, according to an embodiment.

FIG. 2 illustrates an example of a mini-map that provides two-dimensional information on a three-dimensional virtual space, according to an embodiment.

FIGS. 3A and 3B illustrate an example of a screen including a mini-map in which a view point is changed based on an input, according to an embodiment.

FIGS. 4A and 4B illustrate an example of a screen including a visual object that provides information on an object according to an altitude, based on an input to a mini-map, according to an embodiment.

FIG. 5A illustrates an example of a screen including a slider bar that provides information on a density of an object for each altitude, according to an embodiment.

FIGS. 5B and 5C illustrate an example of a screen including a scroll view that displays information of an object according to an altitude, according to an embodiment.

FIG. 6 illustrates an example of an operation flow of a method in which an electronic device changes a view point based on an input in order to provide three-dimensional information through a mini-map, according to an embodiment.

### DESCRIPTION OF EMBODIMENTS

The electronic device (or the external electronic device) according to various embodiments may be one of various types of electronic devices. The electronic devices may include, for example, a portable communication device (e.g., a smartphone), a computer device, a portable multimedia device, a portable medical device, a camera, a wearable device, a server, or a home appliance. According to an embodiment of the disclosure, the electronic devices (or the external electronic device) are not limited to those described above.

It should be appreciated that various embodiments of the present disclosure and the terms used therein are not intended to limit the technological features set forth herein to some embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with the present document, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium that is readable by a machine (e.g., the electronic device 101). For example, a processor of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™ or AppStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to an embodiment, an electronic device may include a mini-map for representing a virtual space in a screen including at least a part of the virtual space. The mini-map may include one or more visual objects. The mini-map may be formed as a two-dimensional plane displayed on the screen. Since the virtual space is formed as a three-dimensional space, a method for providing information on the three-dimensional space through the mini-map may be required.

The technical problems to be achieved in this document are not limited to those described above, and other technical problems not mentioned herein will be clearly understood by those having ordinary knowledge in the art to which the present disclosure belongs, from the following description.

An electronic device may comprise a display, and a processor. The processor may be configured to display, via the display, a screen including at least a part of a virtual space including a player character (PC) corresponding to a user of the electronic device. The screen may include a mini-map for representing the virtual space. The processor may be configured to display, in a first state of the mini-map, the mini-map including a first part of the virtual space viewed along a first direction parallel to an elevation direction of the virtual space, from a first view point above the PC. The processor may be configured to display, based on an input for changing a view point of the mini-map, in a second state changed from the first state, the mini-map including a second part of the virtual space viewed along a second direction different from the first direction, from a second view point different from the first view point.

A method executed by an electronic device may comprise displaying, via a display, a screen including at least a part of a virtual space including a player character (PC) corresponding to a user of the electronic device. The screen may include a mini-map for representing the virtual space. The method may comprise displaying, in a first state of the mini-map, the mini-map including a first part of the virtual space viewed along a first direction parallel to an elevation direction of the virtual space, from a first view point above the PC. The method may comprise displaying, based on an input for changing a view point of the mini-map, in a second state changed from the first state, mini-map including a second part of the virtual space viewed along a second direction different from the first direction, from a second view point different from the first view point.

In a computer-readable storage medium storing one or more programs, the one or more programs may comprise instructions which, when executed by a processor of an electronic device, cause the electronic device to display, via a display of the electronic device, a screen including at least a part of a virtual space including a player character (PC) corresponding to a user of the electronic device. The screen may include a mini-map for representing the virtual space. The one or more programs may comprise instructions which, when executed by the processor of the electronic device, cause the electronic device to display, in a first state of the mini-map, the mini-map including a first part of the virtual space viewed along a first direction parallel to an elevation direction of the virtual space, from a first view point above the PC. The one or more programs may comprise instructions which, when executed by the processor of the electronic device, cause the electronic device to display, based on an input for changing a view point of the mini-map, in a second state changed from the first state, mini-map including a second part of the virtual space viewed along a second direction different from the first direction, from a second view point different from the first view point.

An electronic device according to an embodiment can include a mini-map for representing a virtual space in a screen including at least a part of the virtual space. The mini-map can include one or more visual objects. The mini-map can be formed as a two-dimensional plane displayed on the screen. The electronic device can provide information on the three-dimensional space through the mini-map based on an input to the mini-map.

The effects that can be obtained from the present disclosure are not limited to those described above, and any other effects not mentioned herein will be clearly understood by those having ordinary knowledge in the art to which the present disclosure belongs, from the following description.

Hereinafter, various embodiments of the present document will be described with reference to the accompanying drawings.

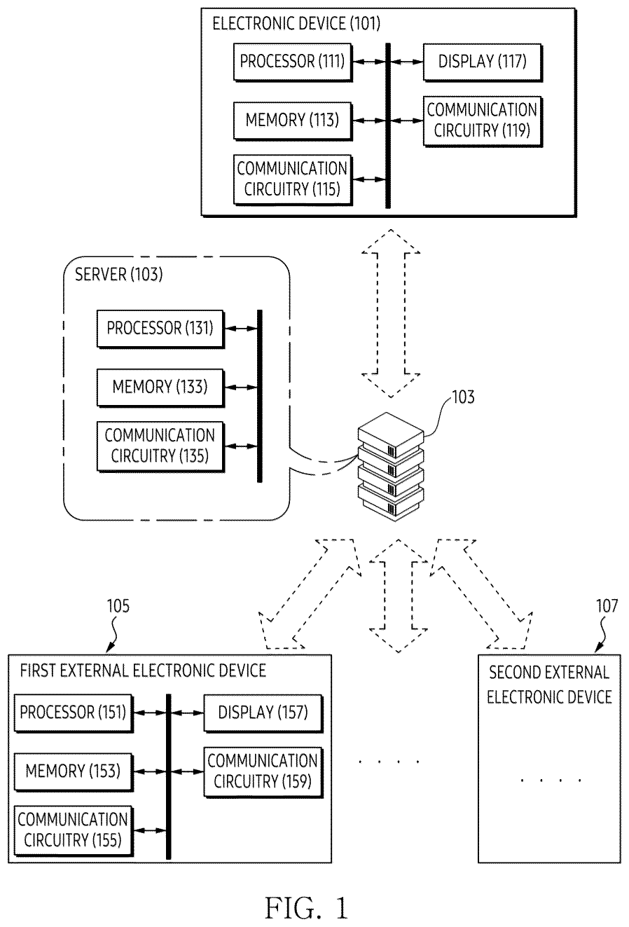

FIG. 1 is an exemplary block diagram of an electronic device in a network environment, according to an embodiment.

Referring to FIG. 1, an environment illustrated in FIG. 1 may include an electronic device 101, a plurality of external electronic devices 105 and 107, and a server 103. The electronic device 101 may be connected to the plurality of external electronic devices 105 and 107 based on a wired network and/or a wireless network. For example, the wired network may include a network such as the Internet, a local area network (LAN), a wide area network (WAN), Ethernet, or a combination thereof. The wireless network may include a network such as long-term evolution (LTE), 5G new radio (NR), wireless fidelity (WiFi), ZigBee, near field communication (NFC), Bluetooth, Bluetooth low energy (BLE), or a combination thereof. In FIG. 1, the electronic device 101 has been illustrated to be directly connected to the plurality of external electronic devices 105 and 107 through the server 103, but is not limited thereto. For example, the electronic device 101 and the plurality of external electronic devices 105 and 107 may be indirectly connected through one or more routers and/or one or more access points (APs).

The server 103 according to an embodiment may mean a server of a service provider. For example, the server 103 may register users of the electronic device 101 and the plurality of external electronic devices 105 and 107, which are client devices, based on linkage with a database that stores user information subscribed to a service (e.g., a multimedia content service or a game service), or may perform user authentication based at least on a relationship between account information received from at least one of the electronic device 101 and the plurality of external electronic devices 105 and 107, and account information stored in the database that stores the user information. For example, the service may include a game service provided to users who subscribe to the service. For example, the service may include a program, an application, and/or a library for providing the game service. For example, the server 103 may provide information on a virtual space related to the game service to the electronic device 101 and the plurality of external electronic devices 105 and 107. The virtual space may represent a virtual environment (or a game environment) implemented in the game service.

According to an embodiment, the electronic device 101 may process, based on linkage with a database (e.g., memory 133 of the server 103) that stores data for execution of a software application (e.g., a game software application) related to the service, an operation request related to the software application received from the plurality of external electronic devices 105 and 107, which are the client devices. The operation request related to the application received from the plurality of external electronic devices 105 and 107 may include avatar information corresponding to each account information of the users.

Referring to FIG. 1, the electronic device 101 according to an embodiment may include a personal computer such as a laptop and a desktop, a smartphone, a smart pad, a tablet, and smart accessories such as a smart watch and a head-mounted device (HMD). For example, the electronic device 101 may include at least one of a processor 111, memory 113, communication circuitry 115, a display 117, or a sensor 119. The processor 111, the memory 113, the communication circuitry 115, the display 117, and/or the sensor 119 may be electronically and/or operably coupled with each other by an electronic component such as a communication bus. A type and/or the number of hardware components included in the electronic device 101 is not limited as illustrated in FIG. 1. For example, the electronic device 101 may include only some of the hardware components illustrated in FIG. 1.

The processor 111 of the electronic device 101 according to an embodiment may include a hardware component for processing data based on one or more instructions. The hardware component for processing data may include, for example, an arithmetic and logic unit (ALU), a field programmable gate array (FPGA), and/or a central processing unit (CPU). The number of processors 111 may be one or more. For example, the processor 111 may have a structure of a multi-core processor such as a dual core, a quad core, or a hexa core.

The memory 113 of the electronic device 101 according to an embodiment may include a hardware component for storing data and/or instructions inputted to and/or outputted from the processor 111. The memory 113 may include, for example, volatile memory such as random-access memory (RAM) and/or non-volatile memory such as a read-only memory (ROM). The volatile memory may include, for example, at least one of dynamic RAM (DRAM), static RAM (SRAM), Cache RAM, and pseudo SRAM (PSRAM). The non-volatile memory may include, for example, at least one of a programmable ROM (PROM), erasable PROM (EPROM), electrically erasable PROM (EEPROM), flash memory, a hard disk, a compact disk, and an embedded multimedia card (eMMC).

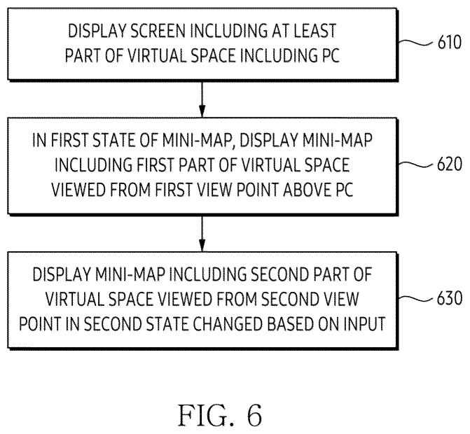

In the memory 113 of the electronic device 101 according to an embodiment, one or more instructions (or commands) representing a calculation and/or an operation to be performed by the processor 111 of the electronic device 101 on data may be stored. A set of the one or more instructions may be referred to as firmware, an operating system, a process, a routine, a sub-routine and/or an application. For example, the electronic device 101 and/or the processor 111 may perform at least one of operations of FIG. 6 when a set of a plurality of instructions distributed in a form of an operating system, firmware, a driver, and/or an application is executed. Hereinafter, an application being installed in the electronic device 101 may mean that one or more instructions provided in a form of the application are stored in the memory 113, and one or more applications are stored in an executable format (e.g., a file with an extension specified by an operating system of the electronic device 101). As an example, the application may include a program and/or a library related to a service provided to a user.

The communication circuitry 115 of the electronic device 101 according to an embodiment may include a hardware component for supporting transmission and/or reception of signals between the electronic device 101 and the plurality of external electronic devices 105 and 107. The communication circuitry 115 may include, for example, at least one of MODEM, an antenna, and an optic/electronic (O/E) converter. For example, the communication circuitry 115 may support transmission and/or reception of signals based on various types of protocols such as Ethernet, a local area network (LAN), a wide area network (WAN), wireless fidelity (WiFi), Bluetooth, Bluetooth low energy (BLE), ZigBee, long term evolution (LTE), and 5G new radio (NR).

The display 117 of the electronic device 101 according to an embodiment may output visualized information to the user by being controlled by a controller such as the processor 111. The display 117 may include a flat panel display (FPD) and/or electronic paper. The FPD may include a liquid crystal display (LCD), a plasma display panel (PDP), and/or one or more light emitting diodes (LEDs). The LED may include an organic LED (OLED). For example, the display 117 may be used to display an image obtained by the processor 111 or an image obtained by display driving circuitry. For example, the electronic device 101 may display an image on a part of the display 117 according to control of the display driving circuitry. However, it is not limited thereto. For example, the electronic device 101 may display, based on receiving information on multimedia content (e.g., a game screen) from the server 103, the multimedia content including an avatar corresponding to the electronic device 101 on the display 117.

The sensor 119 of the electronic device 101 according to an embodiment may detect an input to the display 117. For example, the sensor 119 may detect the input on the display 117 by the user of the electronic device 101. For example, the input may include at least one of a touch input including a contact point with respect to at least a part on the display 117, a drag input to the display 117, or a hovering input to the display 117. For example, the sensor 119 may detect an operating state (e.g., power or temperature) of the electronic device 101 according to the input or an external environmental state (e.g., user state), and generate an electrical signal or a data value corresponding to the detected state. For example, the sensor 119 may include a gesture sensor, a gyro sensor, a barometric pressure sensor, a magnetic sensor, an acceleration sensor, an inertial measurement unit (IMU) sensor, a grip sensor, a proximity sensor, a color sensor, an infrared (IR) sensor, a biometric sensor, a temperature sensor, a humidity sensor, or an illuminance sensor.

The server 103 according to an embodiment may include at least one of a processor 131, the memory 133, and communication circuitry 135. The processor 131, the memory 133, or the communication circuitry 135 may be electronically and/or operably coupled with each other by an electronic component such as a communication bus. A type and/or the number of hardware components included in the server 103 is not limited as illustrated in FIG. 1. For example, the server 103 may include only some of the hardware components illustrated in FIG. 1. For example, the processor 131 may correspond to the processor 111 of the electronic device 101. For example, the memory 133 may correspond to the memory 113 of the electronic device 101. The communication circuitry 135 may correspond to the communication circuitry 155 of the electronic device 101. To reduce repetition of a description, redundant descriptions may be omitted.

The server 103 according to an embodiment may store account information of users subscribed to a service (e.g., a game service) based on the server 103, in the memory 133. For example, the account information of the users may include player character (PC) information corresponding to the account information, in the game service. In addition, for example, the account information of the users may include information on an electronic device owned by the users.

For example, the PC information may include stats, a level, and a skill of the PC and/or external appearance information of the PC. For example, the PC may include a playable character that performs a specified action based on an input of the user related to account information (or an electronic device) corresponding to the PC. For example, the PC may be different from a non-player character (NPC) that the user cannot operate. For example, the NPC may represent a character preset when designing the server 103 that provides a virtual space or the virtual space. For example, the NPC may perform interaction with the PC. For example, the NPC may include a monster. For example, the PC and the NPC may be included in an object (or a target object) that may be a target of the interaction.

For example, the server 103 may detect, based on receiving at least one signal from at least one electronic device owned by the user of the electronic device 101 and/or the plurality of external electronic devices 105 and 107, an input of the user. The electronic device 101 and/or the server 103 may control the PC based on detecting the input of the user.

According to an embodiment, the server 103 may include information for providing a mini-map. For example, the server 103 may include map information of the game service (or multimedia content). For example, the server 103 may generate the mini-map identified based on the map information. For example, server 103 may provide information on the generated mini-map to the electronic device 101 and/or the plurality of external electronic devices 105 and 107. However, the information included in the server 103 is not limited to the above-described example. As an example, it may further include information on a multimedia content service provided by the server 103, such as quest information of the multimedia content.

According to an embodiment, the plurality of external electronic devices 105 and 107 may be owned by different users. For example, the first external electronic device 105 and/or the second external electronic device 107 may include a personal computer such as a laptop and a desktop, a smartphone, a smart pad, a tablet personal computer (PC), and smart accessories such as a smart watch and a head-mounted device (HMD). For example, the plurality of external electronic devices 105 and 107 may be an example of an electronic device that receives a service (e.g., the game service) through the server 103. Each user using the first external electronic device 105 and/or the second external electronic device 107 may be subscribers of the service provided by the electronic device 101. Although only two external electronic devices 105 and 107 are illustrated in FIG. 1, an embodiment of the present disclosure is not limited thereto. For example, the server 103 may be connected to three or more external electronic devices.

The first external electronic device 105 of the plurality of external electronic devices 105 and 107 according to an embodiment may include at least one of a processor 151, memory 153, communication circuitry 155, a display 157, or a sensor 159. The processor 151, the memory 153, the communication circuitry 155, the display 157, and/or the sensor 159 may be electronically and/or operably coupled with each other by an electronic component such as a communication bus. A type and/or the number of hardware components included in the first external electronic device 105 is not limited as illustrated in FIG. 1. For example, the first external electronic device 105 may include only some of the hardware components illustrated in FIG. 1. For example, the processor 151 may correspond to the processor 111 of the electronic device 101. For example, the memory 153 may correspond to the memory 113 of the electronic device 101. The communication circuitry 155 may correspond to the communication circuitry 155 of the electronic device 101. The display 157 may correspond to the display 117 of the electronic device 101. The sensor 159 may correspond to the sensor 119 of the electronic device 101. To reduce repetition of a description, redundant descriptions may be omitted.

According to an embodiment, each (e.g., the second external electronic device 107) of the plurality of external electronic devices 105 and 107 may include at least some or all of the components included in the first external electronic device 105. Each of the plurality of external electronic devices including the second external electronic device 107 may be independently configured by including the at least some or all of the components included in the first external electronic device 105.

As described above, the electronic device 101 according to an embodiment may display a screen including at least a part of the virtual space through the display 117. For example, the screen may include PC corresponding to a first user of the electronic device 101. According to an embodiment, the screen may include a mini-map for representing the virtual space. For example, the mini-map may represent a visual object representing a simplified map of information on the virtual space. For example, the mini-map may include at least one of a first visual object to indicate a reference location in the virtual space of the PC, one or more second visual objects to indicate one or more other objects different from the PC, and an image of an area of the virtual space identified based on the reference location. For example, the area may represent at least a part of the virtual space to be displayed through the mini-map.

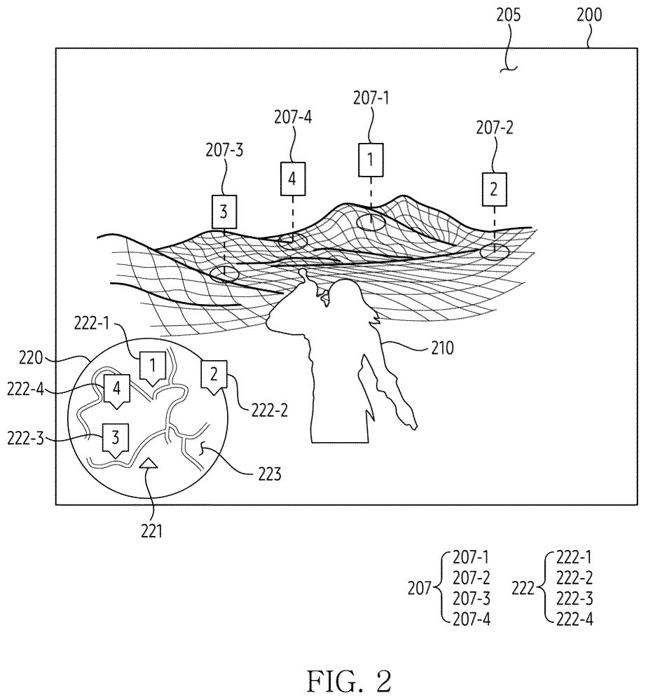

As described above, the electronic device 101 may provide information on the three-dimensional virtual space through the mini-map displayed as a two-dimensional plane based on an input to the mini-map (or user interface (UI) linked to the mini-map) within the screen. Hereinafter, in FIG. 2, an example of a mini-map in which the electronic device 101 provides two-dimensional information will be described.

FIG. 2 illustrates an example of a mini-map that provides two-dimensional information on a three-dimensional virtual space, according to an embodiment.

The virtual space may represent a virtual environment (or a game environment) implemented in the game service. For example, the virtual space may be formed in three dimensions. The mini-map may represent a visual object representing a map in which information on the virtual space is simplified. For example, the mini-map may be formed as a two-dimensional plane.

FIG. 2 illustrates an example of a screen 200 including at least a part of the virtual space. For example, the screen 200 may be displayed through a display (e.g., the display 117 of FIG. 1) of an electronic device 101.

Referring to FIG. 2, the screen 200 may include a virtual space 205 (or a game screen or an in-game screen), a plurality of objects 207, a player character (PC) 210 corresponding to the electronic device 101, and a mini-map 220. The screen 200 illustrated in FIG. 2 is only an example for convenience of explanation, and an embodiment of the present disclosure is not limited thereto. For example, on the screen 200 of FIG. 2, it is illustrated as including the PC 210, a first object 207-1, a second object 207-2, a third object 207-3, and a fourth object 207-4, but the embodiment of the present disclosure is not limited thereto. For example, the screen 200 may include five or more objects or three or less objects. For example, each of the plurality of objects 207 may include PC or NPC, different from the PC 201 corresponding to the electronic device 101.

For example, the virtual space 205 may be formed based on various topographic features. Referring to the screen 200, an example of the virtual space 205 according to a mountainous terrain including a hill is illustrated, but the embodiment of the present disclosure is not limited thereto.

For example, according to topography of the virtual space 205 where an object is located or a state of the object, an altitude (or a z-axis value of the virtual space) of the object may be changed. For example, referring to the screen 200, since the first object 207-1 is located on a relatively higher hill compared to other objects 207-2, 207-3, and 207-4, an altitude of the first object 207-1 may have a higher altitude value than the other objects 207-2, 207-3, and 207-4. In addition, referring to the screen 200, since the third object 207-3 is located below the hill, which is relatively lower compared to other objects 207-1, 207-2, and 207-4, an altitude of the third object 207-3 may have a lower altitude value than the other objects 207-1, 207-2, and 207-4. In the above example, a case in which an altitude of each of the plurality of objects 207 is changed according to the virtual space 205 having the mountainous terrain is illustrated, but the embodiment of the present disclosure is not limited thereto. For example, the altitude of each of the plurality of objects 207 may be changed according to a state of the object. For example, the state of the object may include whether the object is flying or whether the object is located within (or below) (or underground) the terrain.

For example, the mini-map 220 may include a first visual object 221 corresponding to the PC 210, second visual objects 222 corresponding to the plurality of objects 207, and an image 223 of an area of the virtual space 205.

For example, the first visual object 221 may represent a visual object for indicating a reference location in the virtual space 205 of the PC 210. The reference location may represent a location in the virtual space 205 of the PC 210 (e.g., a location on am xy plane and a location (or an altitude) on a z-axis, and a second visual object 222-1 may represent a visual object for indicating a location of the first object 207-1. A second visual object 222-2 may represent a visual object for indicating a location of the second object 207-2. A second visual object 222-3 may represent a visual object for indicating a location of the third object 207-3. A second visual object 222-4 may represent a visual object for indicating a location of the fourth object 207-4. For example, the image 223 may represent a visual object corresponding to the at least part of the virtual space 205 that may be displayed according to the reference location of the PC 210. In the image 223, the at least part of the virtual space 205 expressed through the screen 200 may be expressed in a simplified state.

Referring to FIG. 2, the user of the electronic device 101 may detect a distance (or a distance on the xy plane of the virtual space) separated from the PC 210 with respect to each of the plurality of objects 207 through the mini-map 220. Referring to the mini-map 220, a distance from the PC 210 to the third object 207-3 may be the shortest among the plurality of objects 207. Alternatively, a distance from the PC 210 to the second object 207-2 may be the farthest among the plurality of objects 207. However, even if the user refers to the mini-map 220, it may be difficult for the user to detect an altitude of the plurality of objects 207 in the virtual space 205. This may be because the mini-map 220 is illustrated as a two-dimensional plane, but the virtual space 205 is formed as a three-dimensional space.

Referring to the above, an electronic device, a method, and a computer-readable storage medium according to embodiments of the present disclosure may provide information on a three-dimensional space through the mini-map 220 by changing a view point for viewing the virtual space 205 based on an input to the mini-map 220. Accordingly, users who use the game service associated with the virtual space 205 may increase their immersion in the game service by receiving an intuitive experience for the three-dimensional space.

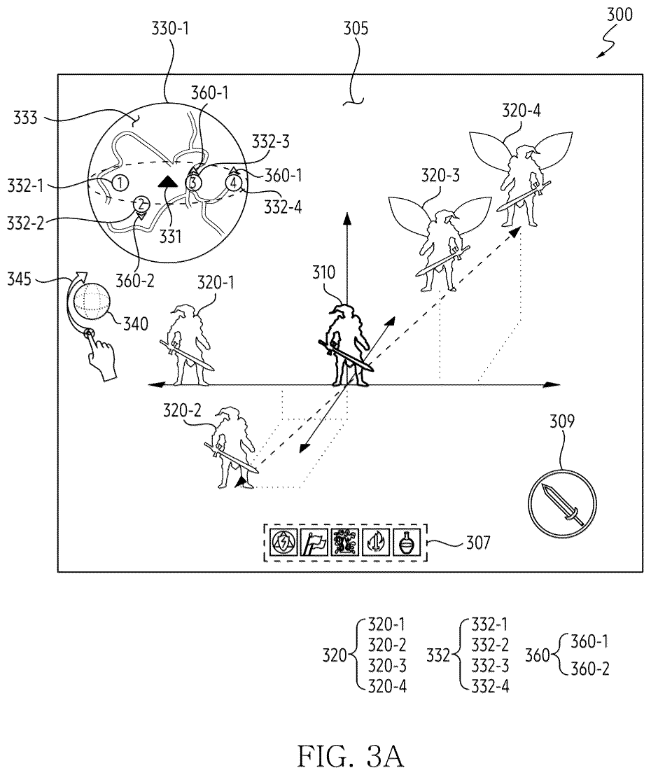

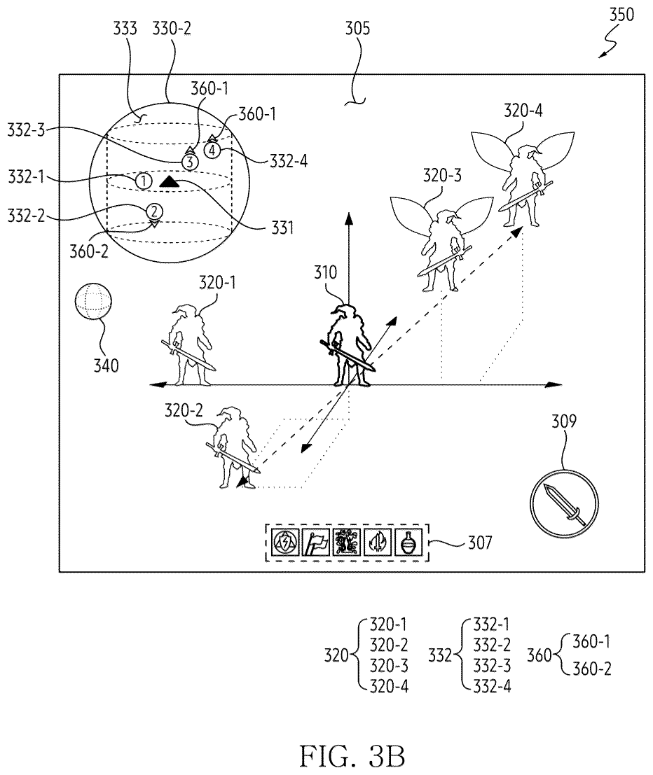

FIGS. 3A and 3B illustrate an example of a screen including a mini-map in which a view point is changed based on an input, according to an embodiment.

The mini-map may represent a visual object representing a map in which information on a virtual space is simplified. For example, the mini-map may be formed as a two-dimensional plane. The virtual space may represent a virtual environment (or a game environment) implemented in the game service. For example, the virtual space may be formed in three dimensions.

Referring to FIGS. 3A and 3B, according to an embodiment, an electronic device 101 may display screens 300 and 350 including at least a part of the virtual space that provides the game service. For example, the electronic device 101 may display the screen 300 or the screen 350 through a display 117.

Referring to FIGS. 3A and 3B, the screen 300 or the screen 350 may include a virtual space 305, a visual object 307 representing a quick slot, an icon 309 for executing an attack, PC 310 corresponding to a user of the electronic device 101, and a plurality of objects 320. However, an embodiment of the present disclosure is not limited thereto. For example, the screen 300 or screen 350 may include at least one of visual objects illustrated in FIGS. 3A and 3B, or may include at least one visual object different from the visual objects.

According to an embodiment, the visual object 307 may represent a configurable slot (or quick slot) so that the user may execute one or more interactions of the PC 201. For example, the visual object 307 may include slots in a 5×1 (horizontal×vertical) arrangement. For example, the electronic device 101 may detect, based on an input to the visual object 307, an interaction corresponding to the input. For example, the electronic device 101 may display a visual effect (e.g., a skill effect) or a visual object according to the identified interaction, through the screen 300 or 350. For example, the interaction may include use of an item or a skill in the virtual space. However, the present disclosure is not limited thereto. According to an embodiment, the icon 309 may represent a visual object for executing an attack of the PC 310. For example, the execution of the attack may be included in the interaction using the PC 310. According to an embodiment, the electronic device 101 may detect the execution of the attack on a target object of the PC 310 based on an input to the icon 309. The target object may represent an object identified as a target of the interaction performed by the PC 310.

Referring to FIGS. 3A and 3B, according to an embodiment, each of the plurality of objects 320 in the screen 300 or the screen 350 may be located differently from a reference location of the PC 310. The reference location may represent a location of the PC 310 in the virtual space 305. For example, the location in the virtual space 305 may be identified based on a plurality of coordinates (x, y, and z) defining the virtual space 305. For example, the x-coordinate and the y-coordinate may represent a distance on a plane in the virtual space 305. For example, the z-coordinate may represent an altitude in the virtual space 305.

For example, referring to the screen 300 or the screen 350, a first object 320-1 may be located on the left side with respect to the PC 310. A second object 320-2 may be located below the left side with respect to the PC 310. A third object 320-3 may be located on the right side with respect to the PC 310. A fourth object 320-4 may be located on the upper right side with respect to the PC 310. In addition, for example, referring to the screen 300 or the screen 350, the first object 320-1 may be located at the same altitude as the PC 310. The second object 320-2 may be located at a lower altitude than the PC 310. The third object 320-3 may be located at a higher altitude than the PC 310. The fourth object 320-4 may be located at a higher altitude than the PC 310 and the third object 320-3.

According to an embodiment, a distance (and a positional relationship) and an altitude between the PC 310 and the plurality of objects 320 as described above may be identified through a mini-map 330-1 or 330-2.

Referring to FIG. 3A, the screen 300 may include the mini-map 330-1 in a first state. For example, the first state may represent a state in which the virtual space 305 is viewed along a first direction parallel to an elevation direction (e.g., a z-axis direction) of the virtual space 305, from a first view point above PC 310. Viewing the virtual space 305 along the first direction parallel to the elevation direction may represent viewing the virtual space 305 along a direction in which an xy plane extends. For example, the first state may be referred to as a bird view or an aerial view. For example, the first view point may represent a virtual point on the PC 310 along the elevation direction. According to an embodiment, the first state may be an initial state of a mini-map displayed on the screen 300. For example, the electronic device 101 may display the screen 300 including the mini-map 330-1 in the first state when the game service is executed for the first time or there is no separate setting.

According to an embodiment, the mini-map 330-1 in the first state may include a first visual object 331, a plurality of second visual objects 332, and an image 333 for a first part. For example, the first visual object 331 may represent a visual object for indicating the reference location in the virtual space 305 of the PC 310. For example, the plurality of second visual objects 332 may be used to indicate the plurality of objects 320 associated with the PC 310. The plurality of objects 320 associated with the PC 310 may represent objects or target objects, identified (or scanned) based on an input to the user. or example, a second visual object 332-1 may represent a visual object for indicating a location of the first object 320-1. A second visual object 332-2 may represent a visual object for indicating a location of the second object 320-2. A second visual object 332-3 may represent a visual object for indicating a location of the third object 320-3. A second visual object 332-4 may represent a visual object for indicating a location of the fourth object 320-4. According to an embodiment, the first visual object 331 and the plurality of second visual objects 332 may be displayed in a floated state with respect to the image.

According to an embodiment, the first part may represent an area of the virtual space 305 that may be displayed according to the reference location of the PC 310. For example, the image 333 may be defined as a visual element for the first part. For example, the mini-map 330-1 may include the image 333 for the first part of the the virtual space 305 viewed along the first direction, from the first view point above the PC 310. For example, the first part may represent a two-dimensional plane of the virtual space 305 that changes according to the reference location of the PC 310 and faces the elevation direction. For example, the two-dimensional plane representing the first part may represent at least a partial area of the virtual space 305 projected with respect to a virtual plane including the reference location of the PC 310 parallel to the xy plane of the virtual space 305.

According to an embodiment, the plurality of objects 320 may be categorized based on their altitude relative to the reference range. For purposes of illustration, objects located at different altitude ranges may be designated as follows: a “first object” may represent any object located at an altitude higher than the reference range, a “second object” may represent any object located at an altitude lower than the reference range, and a “third object” may represent any object located within the reference range. It should be understood that multiple objects may exist in each altitude range, and the terms “first object,” “second object,” and “third object” may refer to one or more representative objects in their respective altitude ranges.

According to an embodiment, the user of the electronic device 101 may detect a distance on a plane in the virtual space 305 between the PC 310 and the plurality of objects 320, based on the mini-map 330-1. For example, the distance may be identified based on the first visual object 331 and the second visual objects 332 of the mini-map 330-1. For example, the user may detect the distance between the PC 310 and the third object 320-3 is the closest among the plurality of objects 320, based on the second visual object 331 and the third object 320-3. In addition, for example, the user may detect the distance between the PC 310 and the fourth object 320-4 is the farthest of the plurality of objects 320, based on the second visual object 331 and the fourth object 320-4. However, even if the mini-map 330-1 in the first state is used, it may be difficult to detect an altitude between the PC 310 and the plurality of objects 320. In order to easily detect the altitude, a mini-map 330-2 of a second state different from the first state of FIG. 3B may be used.

According to an embodiment, the electronic device 101 may include a ball-shaped user interface (UI) 340 in the screen 300 or the screen 350. For example, the UI 340 may be located adjacent to the mini-map 330-1 or the mini-map 330-2. According to an embodiment, the electronic device 101 may change a view point of the mini-map 330-1 or the mini-map 330-2 based on an input to the UI 340. For example, referring to the screen 300, the electronic device 101 may obtain an input 345 to the UI 340 in a state of displaying the mini-map 330-1 in the first state. For example, the input 345 may include a drag input to the UI 340. For example, the electronic device 101 may display the UI 340 rotating along the first drag direction based on detecting the drag input facing the first drag direction. For example, the electronic device 101 may change the view point from the first view point to a second view point based on detecting the drag input facing the first drag direction. For example, the first drag direction may represent a direction approaching the mini-map 330-1 from a far location. For example, the second view point may be different from the first view point. For example, the electronic device 101 may change an area of the virtual space 305 displayed on the mini-map 330-1 from the first part to a second part while changing from the first view point to the second view point. Changing the area of the virtual space 305 from the first part to the second part may be understood substantially the same as changing the mini-map 330-1 of the first state to the mini-map 330-2 of the second state different from the first state.

Referring to FIG. 3B, the screen 350 may include the mini-map 330-2 in the second state. For example, the second state may represent a state of the virtual space 305 is viewed along a second direction different from the first direction, from the second view point different from the first direction. For example, the second state may be referred to as a side view. For example, the second view point may represent another virtual point that has rotated and moved by a specified elevation angle with respect to an axis representing the elevation direction from the virtual point on the PC 310 associated with the first view point. For convenience of explanation, in FIG. 3B, the second state when the second direction is perpendicular to the first direction (i.e., the elevation angle is 90°) is described as an example. However, an embodiment of the present disclosure is not limited thereto. For example, the second direction may be rotated and moved by less than 90° or more than 90° with respect to the first direction.

According to an embodiment, the mini-map 330-2 in the second state may include the first visual object 331, the plurality of second visual objects 332, and the image 333 for the first part. To reduce repetition of explanation, redundant explanations may be omitted.

According to an embodiment, the second part may represent an area of the virtual space 305 that may be displayed according to the reference location of the PC 310. For example, the image 333 may be defined as a visual element for the second part. For example, the mini-map 330-2 may include the image 333 for the second part of the virtual space 305 viewed along the second direction, from the second view point above the PC 310. For example, when the second direction is perpendicular to the first direction, the second part may represent a two-dimensional plane of the virtual space 305 parallel to the elevation direction. For example, the two-dimensional plane representing the second part may represent at least a partial area of the virtual space 305 projected with respect to the virtual surface including a z-axis of the virtual space 305. For example, the second part may be changed according to the reference location of the PC 310. In addition, for example, the second part may be changed based on an angle formed by the second direction with the first direction.

According to an embodiment, the user of the electronic device 101 may detect an altitude in the virtual space 305 between the PC 310 and the plurality of objects 320 based on the mini-map 330-2. For example, the altitude may be identified based on the first visual object 331 and the second visual objects 332 of the mini-map 330-2. For example, the user may detect that an altitude of the PC 310 and an altitude of the first object 320-1 are same, based on the first visual object 331 and the second visual object 332-1 corresponding to the first object 320-1. In addition, for example, the user may detect that an altitude of the fourth object 320-4 is higher than the altitude of the PC 310, based on the first visual object 331 and the second visual object 332-4 corresponding to the fourth object 320-4. In addition, for example, the user may detect that an altitude of the second object 320-2 is lower than the altitude of the PC 310, based on the first visual object 331 and the second visual object 332-2 corresponding to the second object 320-2.

In some embodiment, when an object is identified in each altitude range, the indicating bar 430 may include icons that directly correspond to individual objects. For example, the first icon 431 may be associated with the first object, the second icon 432 with the second object, and the third icon 433 with the third object. The processor may activate each icon based on the selection or highlighting of its corresponding object's third visual object.

According to an embodiment, the electronic device 101 may display the mini-map 330-1 or 330-2 including an indicator 360 for indicating a relative altitude with respect to the PC 310 of an object. For example, the indicator 360 may be displayed adjacent to the second visual object. According to an embodiment, the indicator 360 may include a first indicator 360-1 for indicating that the PC 310 is located at an altitude higher than a reference range extending from the reference location and a second indicator 360-2 for indicating that the PC 310 is located at an altitude lower than the reference range. According to an embodiment, the reference range may represent a virtual space extending along the elevation direction from the reference location. For example, the reference range may represent an area extending in an upward direction (e.g., +z direction) and a downward direction (e.g., −z direction) along the elevation direction from the reference location.

For example, referring to the mini-map 330-1 or 330-2, the first indicator 360-1 may be displayed adjacent to each of the second visual object 332-3 corresponding to the third object 320-3 and the second visual object 332-4 corresponding to the fourth object 320-4. In addition, for example, the second indicator 360-2 may be displayed adjacent to the second visual object 332-2 corresponding to the second object 320-2.

Referring to the above, an embodiment of changing from the mini-map 330-1 in the first state to the mini-map 330-2 in the second state based on the input (e.g., the drag input with the first drag direction) to the UI 340 is described, but the embodiment of the present disclosure is not limited thereto. For example, embodiments of the present disclosure may also be applied to a case in which the mini-map 330-2 in the second state is changed to the mini-map 330-1 in the first state, based on another input (e.g., another drag input with the second drag direction opposite to the first drag direction) to the UI 340.

Additionally, in FIGS. 3A and 3B, a case in which the second direction indicates a direction changed by 90° from the first direction based on the input (e.g., the drag input with the first drag direction) to the UI 340 was described as an example, but the embodiment of this disclosure is not limited thereto. According to an embodiment, the electronic device 101 may detect an angle at which the second direction rotates and moves from the first direction based on a degree of the input to the UI 340. For example, the electronic device 101 may detect an angle at which the UI 340 rotates based on the input. For example, when the angle has a first value, the electronic device 101 may detect the second view point changed by a first elevation angle from the first view point. Alternatively, when the angle has a second value greater than the first value, the electronic device 101 may detect the second view point changed by a second elevation angle greater than the first elevation angle from the first view point. Accordingly, the electronic device 101 may display the mini-map 330-2 including the second part of the virtual space 305 viewed along the second direction (e.g., a direction changed by the first elevation angle or the second elevation angle, from the first direction) from the identified second view point.

In FIGS. 3A and 3B, an embodiment of changing a view point based on the input (or drag input) to the UI 340 is described, but the embodiment of the present disclosure is not limited thereto. For example, the electronic device 101 may change the view point based on a drag input to the mini-map 330-1 or 330-2. In other words, the electronic device 101 may display the screen 300 or 350 that does not include the UI 340.

In addition, in FIGS. 3A and 3B, a periphery representing an appearance of the mini-map 330-1 and the mini-map 330-2 is illustrated as having a ball (or sphere) shape corresponding to the UI 340, but the embodiment of the present disclosure is not limited thereto. For example, the periphery may be illustrated in a square shape.

In addition, in FIGS. 3A and 3B, an embodiment in which the view point for the mini-map 330-1 of the screen 300 and the mini-map 330-2 of the screen 350 is changed is described, but the embodiment of the present disclosure is not limited thereto. For example, the embodiments of the present disclosure may also be applied to a map screen (not illustrated) capable of entering based on an input to an icon in the screen 300 or the screen 350. For example, based on detecting the input to the icon for entering the map screen, the electronic device 101 may display the map screen. The electronic device 101 may change a view point for the map screen based on an input to UI displayed with the map screen. In addition, the electronic device 101 may change the view point for the map screen based on an input to the map screen.

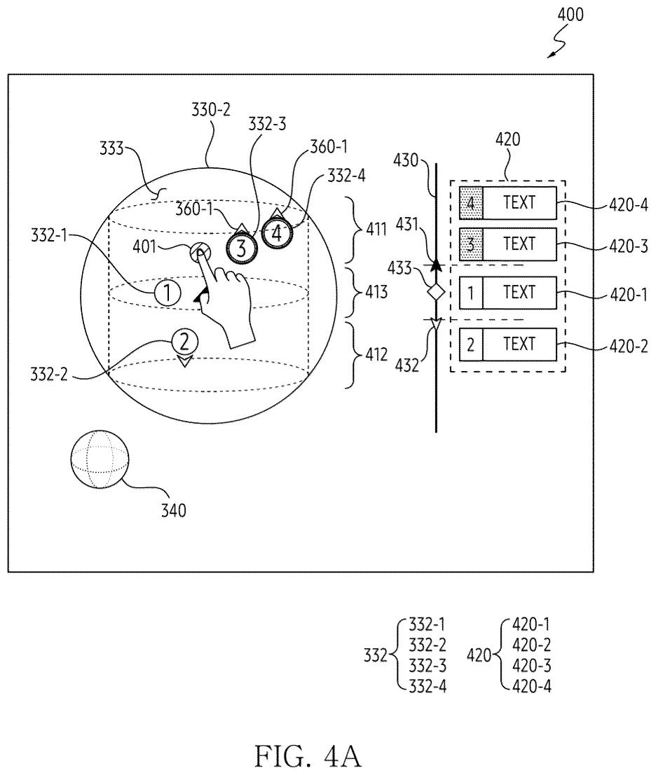

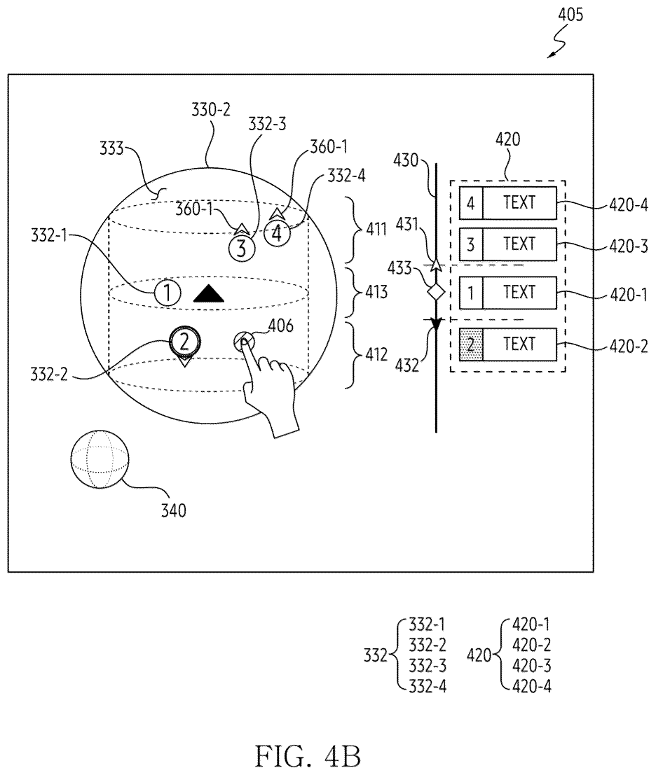

FIGS. 4A and 4B illustrate an example of a screen including a visual object that provides information on an object according to an altitude, based on an input to a mini-map, according to an embodiment.

A mini-map 330-2 of FIGS. 4A and 4B may represent a mini-map in the second state (or a side view). For example, the mini-map 330-2 of FIGS. 4A and 4B may represent an example of the mini-map 330-2 of FIG. 3B. The mini-map 330-2 of FIGS. 4A and 4B may be substantially the same as the mini-map 330-2 of FIG. 3B. Hereinafter, to reduce repetition of explanation, redundant explanations may be omitted.

FIGS. 4A and 4B illustrate examples of screens 400 and 405 including a visual object providing information on an object based on an input to the mini-map 330-2. According to an embodiment, an electronic device 101 may display the screen 400 (or the screen 405) through a display (e.g., the display 117 of FIG. 1). The screen 400 or the screen 405 may represent a part of the screen 300 of FIG. 3A or the screen 350 of FIG. 3B. However, this is only for convenience of explanation, and an embodiment of the present disclosure is not limitedly interpreted.

According to an embodiment, the screen 400 (or the screen 405) may include the mini-map 330-2 in the second state, UI 340, an indicating bar 430, and one or more third visual objects 420. According to an embodiment, the indicating bar 430 may be located adjacent to the mini-map 330-2. In addition, according to an embodiment, the one or more third visual objects 420 may be located adjacent to the indicating bar 430. For example, the indicating bar 430 may represent a visual object for representing a relative altitude of PC of the object. The PC may represent a character corresponding to a user of the electronic device 101. For example, each of the one or more third visual objects 420 may represent a visual object for representing simplified information of the object. For example, in FIGS. 4A and 4B, an example of the screen 400 (or the screen 405) including four third visual objects 420-1, 420-2, 420-3, and 420-4 corresponding to four objects is described, but the embodiment of the present disclosure is not limited thereto.

According to an embodiment, the indicating bar 430 may include a first icon 431 indicating that the object is located at an altitude in the virtual space higher than a reference range, a second icon 432 indicating that the object is located at an altitude in the virtual space lower than the reference range, and a third icon 433 indicating that the object is located at an altitude in the virtual space within the reference range. According to an embodiment, the reference range may represent a virtual space extending along an elevation direction from the reference location. For example, the reference range may represent an area extending in an upward direction (e.g., +z direction) and a downward direction (e.g., −z direction) along the elevation direction from the reference location.

According to an embodiment, each of the one or more third visual objects 420 may include text representing information of the object. For example, the text may include at least one of a level of the object, a name of the object, or an altitude of the object.

According to an embodiment, the mini-map 330-2 may be divided into a plurality of areas. For example, the mini-map 330-2 may be divided into a first area 411 for indicating an altitude higher than the reference range, a second area 412 for indicating an altitude lower than the reference range, and a third area 413 for indicating an altitude corresponding to the reference range.

According to an embodiment, the electronic device 101 may activate an icon of the indicating bar 430 and a part of the one or more third visual objects 420 based on an area in which a touch input to the mini-map 330-2 is located. The activating may represent displaying the icon and the part that are visually highlighted. Conversely, deactivating may represent that a visually emphasized state is released. The deactivating may be performed when an input to an area corresponding to the activated icon and the third visual object is identified, or a specified time elapses.

Referring to an example of FIG. 4A, the electronic device 101 may detect a touch input 401 to the first area 411. Based on the touch input 401, the electronic device 101 may activate the first icon 431, the third visual object 420-3 corresponding to a third object, and the third visual object 420-3 corresponding to a fourth object. According to an embodiment, the electronic device 101 may display a visual effect on a second visual object 332-3 corresponding to the third object and a second visual object 332-4 corresponding to the fourth object, in the mini-map 330-2. For example, the visual effect may include a band-shaped visual object formed along a periphery of the second visual object. The visual effect may also be released in response to the activated icon and the third visual object being deactivated.

Referring to the example of FIG. 4B, the electronic device 101 may detect a touch input 406 for the second area 412. Based on the touch input 406, the electronic device 101 may activate the second icon 432 and a third visual object 420-2 corresponding to a second object. According to an embodiment, the electronic device 101 may display the visual effect on the second visual object 332-2 corresponding to the second object in the mini-map 330-2.

Although not illustrated in FIGS. 4A and 4B, the electronic device 101 may activate the third icon 433 and the third visual object 420-1 corresponding to a first object, based on detecting a touch input to the third area 413. In addition, accordingly, the electronic device 101 may display the visual effect on the second visual object 332-1 corresponding to the first object in the mini-map 330-2.

In FIGS. 4A and 4B, the screen 400 (or the screen 405) including the mini-map 330-2 in the second state is described as an example, but the embodiment of the present disclosure is not limited thereto. For example, the indicating bar 430 and the one or more visual objects 420 according to embodiments of the present disclosure may also be displayed for the mini-map 330-1 in the first state.

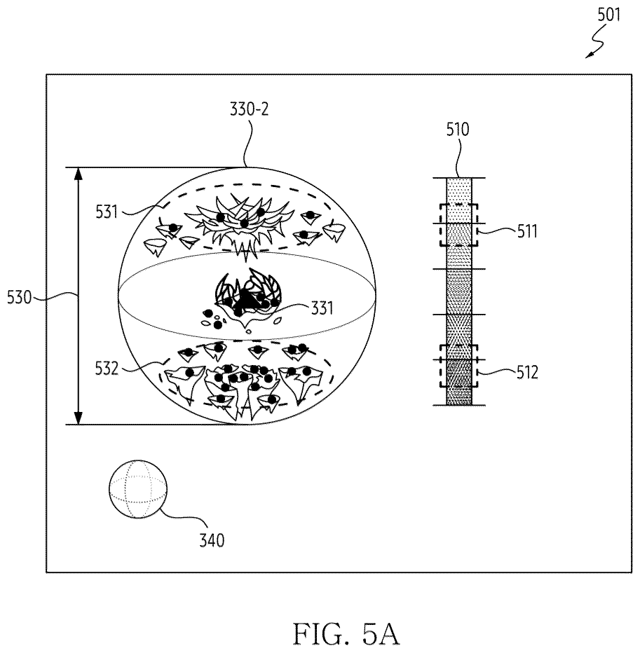

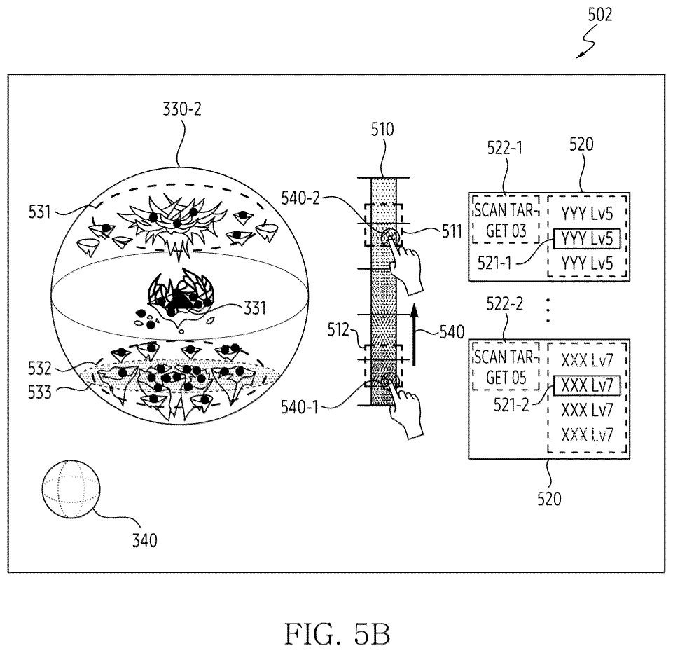

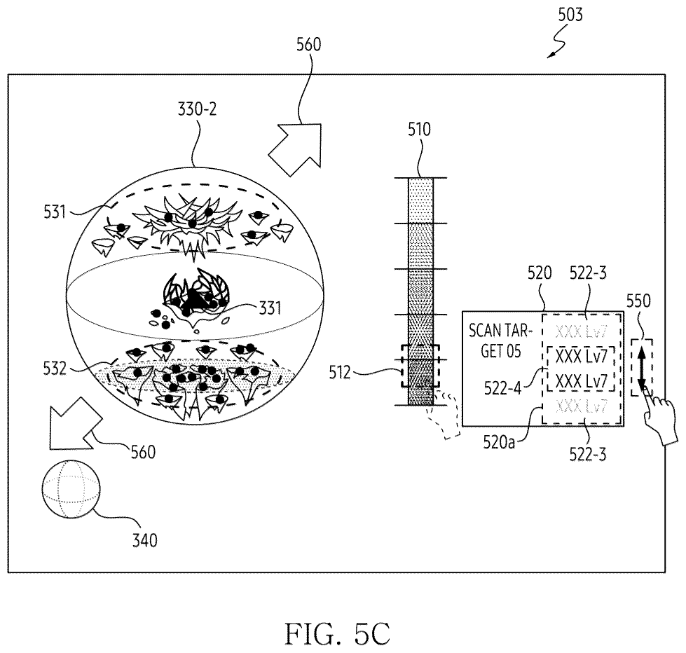

FIG. 5A illustrates an example of a screen including a slider bar that provides information on a density of an object for each altitude, according to an embodiment.

A mini-map 330-2 of FIG. 5A may represent a mini-map in the second state (or a side view). For example, the mini-map 330-2 of FIG. 5A may represent an example of the mini-map 330-2 of FIG. 3B. Content with respect to the mini-map 330-2 of FIG. 3B may be substantially equally applied to the mini-map 330-2 of FIG. 5A. Hereinafter, to reduce repetition of explanation, redundant explanations may be omitted.

FIG. 5A illustrates an example of a screen 501 including a slider bar 510 displayed adjacent to the mini-map 330-2. According to an embodiment, an electronic device 101 may display the screen 501 through a display (e.g., the display 117 of FIG. 1). The screen 501 may represent the part of the screen 300 of FIG. 3A or the screen 350 of FIG. 3B. However, this is only for convenience of explanation, and an embodiment of the present disclosure is not limitedly interpreted.

According to an embodiment, the screen 501 may include the mini-map 330-2 in the second state, UI 340, and the slider bar 510. For example, the slider bar 510 may include a visual object representing a density of an object according to an altitude in the virtual space. The density of the object may be identified based on the number of objects according to an altitude.

According to an embodiment, the electronic device 101 may detect an input to the slider bar 510. For example, the input to the slider bar 510 may be referred to as a swipe input or a swipe. The electronic device 101 may further display a scroll view 520 representing information on an object according to an altitude based on the input to the slider bar 510. Content associated with this will be described with reference to FIGS. 5B and 5C below.

According to an embodiment, the slider bar 510 may be displayed adjacent to the mini-map 330-2. For example, a length of the slider bar 510 displayed adjacent to the mini-map 330-2 may correspond to a length 530 of the mini-map 330-2.

The mini-map 330-2 of FIG. 5A may include a first visual object 331 representing a reference location of PC corresponding to a user of the electronic device 101, second visual objects 531 corresponding to first objects located at a first altitude higher than a reference range, and second visual objects 532 corresponding to second objects located at a second altitude lower than the reference range. For example, there may be more second visual objects 532 than second visual objects 531. An example of FIG. 5A is only for convenience of explanation, and the embodiment of the present disclosure is not limited thereto.

According to an embodiment, the electronic device 101 may detect a brightness of the slider bar 510 based on a density of an object. Referring to an example of FIG. 5A, a first segment 511 of the slider bar 510 may have a first brightness. The first segment 511 may represent a segment of the slider bar 510 corresponding to the first altitude. In addition, referring to an example of FIG. 5A, a second segment 512 of the slider bar 510 may have a second brightness. The second segment 512 may indicate a segment of the slider bar 510 corresponding to the second altitude. In this case, the second brightness may be brighter than the first brightness. However, the embodiment of the present disclosure is not limited thereto. For example, a shape or a color may be changed instead of the brightness.

In FIG. 5A, the screen 501 including the mini-map 330-2 in the second state is described as an example, but the embodiment of the present disclosure is not limited thereto. For example, the slider bar 510 according to embodiments of the present disclosure may also be displayed for the mini-map 330-1 in the first state.

FIGS. 5B and 5C illustrate an example of a screen including a scroll view that displays information of an object according to an altitude, according to an embodiment.

The mini-map 330-2 of FIGS. 5B and 5C may represent a mini-map in the second state (or a side view). For example, the mini-map 330-2 of FIGS. 5B and 5C may represent an example of the mini-map 330-2 of FIG. 3B. Content with respect to the mini-map 330-2 of FIG. 3B may be substantially equally applied to the mini-map 330-2 of FIGS. 5B and 5C. Hereinafter, to reduce repetition of explanation, redundant explanations may be omitted.

Referring to FIG. 5B, according to an embodiment, a screen 502 may include a mini-map 330-2 in the second state, UI 340, a slider bar 510, and a scroll view 520. For example, the scroll view 520 may represent a visual object displayed based on an input (e.g., a swipe input) to the slider bar 510.

According to an embodiment, the scroll view 520 may include text representing information on an object. For example, the text may include the number of objects located at an altitude in the virtual space corresponding to the input, a name of the object located at the altitude, or a level of the object located at the altitude. However, an embodiment of the present disclosure is not limited thereto.

According to an embodiment, the scroll view 520 may be displayed adjacent to the slider bar 510. For example, the scroll view 520 may be displayed on an area corresponding to a segment of the slider bar 510 where the input is located based on the input to the slider bar 510 being identified.

According to an embodiment, an electronic device 101 may change information included in the scroll view 520 based on the input to the slider bar 510. Referring to FIG. 5B, the electronic device 101 may detect a swipe input 540 from a second segment 512 of the slider bar 510 toward a first segment 511. For example, the electronic device 101 may display the scroll view 520 including information on objects corresponding to the second segment 512 based on detecting that a first partial input 540-1 of the swipe input 540 starts. For example, the information on the objects corresponding to the second segment 512 may include text 522-2 representing the number (e.g., 5) of objects located at a second altitude and text 521-2 representing a name (e.g., XXX) and a level (e.g., Lv.7) of the objects located at the second altitude. In addition, for example, the electronic device 101 may display the scroll view 520 including information on objects corresponding to the first segment 511, based on detecting a second partial input 540-2 extended and moved from the first partial input 540-1 of the swipe input 540. For example, the information on the objects corresponding to the second segment 512 may include text 522-1 representing the number (e.g., 3) of objects located at the first altitude and text 521-1 representing a name (e.g., YYY) and a level (e.g., Lv.5) of the objects located at the first altitude. In other words, the electronic device 101 may sequentially change the scroll view 520 including the information on the objects located at the first altitude from the scroll view 520 including the information on the objects located at the second altitude according to the swipe input 540. Although only the second altitude and the first altitude are illustrated in FIG. 5B, the scroll view 520 may include information on at least one object corresponding to an altitude between the second altitude and the first altitude. In addition, in an example of FIG. 5B, the scroll view 520 including information on a plurality of objects is illustrated, but the embodiment of the present disclosure is not limited thereto. For example, the scroll view 520 may include information on at least one object or may not include information on an object.

According to an embodiment, as the swipe input 540 to the slider bar 510 moves, the electronic device 101 may display a visual object 533 representing an area of a scan target. For example, the electronic device 101 may display the mini-map 330-2 including the visual object 533 representing the area of the scan target based on detecting the first partial input 540-1. For example, the area of the scan target may represent an altitude.

Referring to FIG. 5C, according to an embodiment, a screen 503 may include the mini-map 330-2 in the second state, the UI 340, the slider bar 510, and the scroll view 520. For example, the scroll view 520 may represent a visual object displayed based on an input (e.g., a swipe input) to the slider bar 510. Content with respect to the screen 502 of FIG. 5B may be substantially equally applied to content with respect to the screen 503 of FIG. 5C. Hereinafter, to reduce repetition of explanation, redundant explanations may be omitted.

According to an embodiment, the electronic device 101 may detect an input to the scroll view 520. For example, the electronic device 101 may display the scroll view 520 including at least one object information corresponding to the second segment 512 in which the input is released, based on detecting that the input to the slider bar 510 (e.g., the swipe input 540) is released. The electronic device 101 may obtain another input 550 for a part 520a of the scroll view 520 displayed in response to the input to the slider bar 510 being released. For example, the other input 550 may include a scroll input or a scroll. The scroll input may be used to detect information on objects corresponding to a segment when the number of the objects corresponding to the segment (e.g., the second segment 512) exceeds a reference number. For example, the reference number may be identified based on an amount of information on objects that the scroll view 520 may display at once. For example, when the amount (or the reference number) of information on the objects that scroll view 520 may display at once is information on four objects, and the number of five objects corresponding to the second segment 512 is 5, information on the remaining one object may be identified based on the other input 550. According to an embodiment, a brightness for displaying information on objects included in the scroll view 520 may be identified according to a location of the information. For example, the top and the bottom information 522-3 of the information on the objects that the scroll view 520 may display at once may be displayed relatively blurred compared to remaining information 522-4.

According to an embodiment, the electronic device 101 may change a size of an area displayed through the mini-map 330-2. For example, the electronic device 101 may change the size based on an input 560 to an adjacent area of the mini-map 330-2. For example, the adjacent area may represent an area within a specified distance from the mini-map 330-2. For example, the input 560 to the adjacent area may include a pinch-out gesture or a pinch-in gesture. For example, the electronic device 101 may display the zoomed-in mini-map 330-2 based on detecting the pinch-out gesture for the adjacent area. Alternatively, for example, the electronic device 101 may display the zoomed-out mini-map 330-2 based on detecting the pinch-in gesture for the adjacent area. According to the zoom-in or the zoom-out, the size of the area displayed through the mini-map 330-2 may be changed. Referring to FIG. 5C, the electronic device 101 may display a screen including the zoomed-in mini-map 330-2 based on the input 560, which is the pinch-out gesture. In the above-described example, an embodiment of detecting the pinch-out gesture for the adjacent area is described, but the embodiment of the present disclosure is not limited thereto. For example, based on detecting an input including the pinch-out gesture for the mini-map 330-2, the size of the area displayed through the mini-map 330-2 may be changed.

FIG. 6 illustrates an example of an operation flow of a method in which an electronic device changes a view point based on an input in order to provide three-dimensional information through a mini-map, according to an embodiment.

The electronic device of FIG. 6 may include the electronic device 101 of FIG. 1. At least one of operations of FIG. 6 may be performed by the electronic device 101 of FIG. 1. For example, the at least one of the operations may be controlled by the processor 111 of FIG. 1. Each of the operations of FIG. 6 may be performed sequentially, but is not necessarily performed sequentially. For example, an order of each of the operations may be changed, and at least two operations may be performed in parallel.

In operation 610, the electronic device 101 may display a screen including at least a part of a virtual space including PC. For example, the electronic device 101 may display the screen including the at least a part of the virtual space including the PC corresponding to a user of the electronic device 101, through a display (e.g., the display 117 of FIG. 1).

According to an embodiment, the screen may include the at least a part of the virtual space, the PC corresponding to the user, and a mini-map for indicating the virtual space. For example, the screen may include the screen 300 of FIG. 3A or the screen 350 of FIG. 3B. However, an embodiment of the present disclosure is not limited thereto.

According to an embodiment, the mini-map may include a first visual object for indicating a reference location in the virtual space of the PC, one or more second visual objects corresponding to one or more objects, and an image representing an area of the virtual space. For example, each of the one or more second visual objects may be used to indicate a relative location of a corresponding object with respect to the reference location. In the above-described example, the mini-map is illustrated as including the one or more second visual objects, but the mini-map may not include the second visual object. According to an embodiment, the first visual object and the one or more second visual objects may be displayed in a floated state with respect to the image.

In operation 620, in a first state of the mini-map, the electronic device 101 may display the mini-map including a first part of the virtual space viewed from a first view point above the PC. For example, in the first state of the mini-map, the electronic device 101 may display the mini-map including the first part of the virtual space viewed along a first direction parallel to an elevation direction (e.g., the z-axis of FIGS. 3A and 3B) of the virtual space, from the first view point above the PC. For example, the first state may be referred to as a bird view or an aerial view. For example, the first view point may represent a virtual point on the PC along the elevation direction.

According to an embodiment, the first state may be an initial state of the mini-map displayed on the screen. For example, the electronic device 101 may display the screen including the mini-map in the first state when the game service is executed for the first time or there is no separate setting.

According to an embodiment, the first part may represent an area of the virtual space that may be displayed according to the reference location of the PC. For example, the image may be defined as a visual element for the first part. For example, the mini-map in the first state may include the image with respect to the first part of the virtual space viewed along the first direction, from the first view point on the PC. For example, the first part may represent a two-dimensional plane of the virtual space that changes according to the reference location of the PC and faces the elevation direction. For example, the two-dimensional plane representing the first part may represent at least a partial area of the virtual space projected with respect to the virtual surface including the reference location of the PC parallel to an xy plane of the virtual space.

In operation 620, the electronic device 101 may display the mini-map including a second part of the virtual space viewed from the second view point in a second state changed based on an input. For example, the electronic device 101 may detect the input for changing a view point of the mini-map. For example, the electronic device 101 may detect the second view point different from the first view point in the second state changed from the first state based on the input. For example, the electronic device 101 may display the mini-map including the second part of the virtual space viewed along a second direction different from the first direction, from the second view point.

According to an embodiment, the second state may indicate a state in which the virtual space is viewed along the second direction different from the first direction, from the second view point different from the first direction. For example, the second state may be referred to as a side view. For example, the second view point may represent another virtual point that has rotated and moved by a specified elevation angle with respect to an axis (e.g., z-axis) representing the elevation direction from the virtual point associated with the first view point.

According to an embodiment, the second part may represent an area of the virtual space that may be displayed according to the reference location of the PC. For example, when the second direction is perpendicular to the first direction, the second part may represent a two-dimensional plane of the virtual space parallel to the elevation direction. For example, the two-dimensional plane representing the second part may represent at least a partial area of the virtual space projected with respect to the virtual surface including the z-axis of the virtual space. For example, the second part may be changed according to the reference location of the PC. In addition, for example, the second part may be changed based on an angle formed by the second direction with the first direction.

According to an embodiment, the input may include a drag input to a ball-shaped UI displayed adjacent to the mini-map. In the above example, it is illustrated that the UI has a ball shape, but the embodiment of the present disclosure is not limited thereto. For example, the electronic device 101 may display the screen including the mini-map and the UI. For example, the electronic device 101 may obtain the drag input facing a first drag direction with respect to the UI. The first drag direction may represent a direction approaching the mini-map from a far location. However, the embodiment of the present disclosure is not limited thereto. According to an embodiment, the input may include the drag input to the mini-map.

According to an embodiment, the electronic device 101 may change an area of the virtual space displayed on the mini-map from the first part to the second part while changing from the first view point to the second view point. Changing the area of the virtual space from the first part to the second part may be understood in substantially the same manner as changing the mini-map in the first state to the mini-map in the second state.

According to an embodiment, the electronic device 101 may display the mini-map including an indicator for indicating a relative altitude of the object with respect to the PC. For example, the indicator may be displayed adjacent to the second visual object. According to an embodiment, the indicator may include a first indicator for indicating that the PC is located at an altitude higher than a reference range extending from the reference location, and a second indicator for indicating that the PC is located at an altitude lower than the reference range. According to an embodiment, the reference range may represent a virtual space extending along the elevation direction from the reference location. For example, the reference range may represent an area extending in an upward direction (e.g., +z direction) and a downward direction (e.g., −z direction) along the elevation direction from the reference location.

According to an embodiment, the electronic device 101 may detect an angle at which the second direction rotates and moves from the first direction based on a degree of the input to the UI. For example, the electronic device 101 may detect an angle at which the UI rotates based on the input.

As described above, an electronic device may comprise a display, and a processor. The processor may be configured to display, via the display, a screen including at least a part of a virtual space including a player character (PC) corresponding to a user of the electronic device. The screen may include a mini-map for representing the virtual space. The processor may be configured to display, in a first state of the mini-map, the mini-map including a first part of the virtual space viewed along a first direction parallel to an elevation direction of the virtual space, from a first view point above the PC. The processor may be configured to display, based on an input for changing a view point of the mini-map, in a second state changed from the first state, the mini-map including a second part of the virtual space viewed along a second direction different from the first direction, from a second view point different from the first view point.

According to an embodiment, the mini-map may include a first visual object indicating a reference location in the virtual space of the PC, one or more second visual objects indicating one or more objects associated with the PC, and an image of an area of the virtual space. The first visual object and the one or more second visual objects may be displayed in a floated state with respect to the image. The area may include the first part and the second part.

According to an embodiment, when the one or more objects include an object located at an altitude in the virtual space different from a reference range, the mini-map may display an indicator displayed with a second visual object corresponding to an object located at an altitude in the virtual space different from the reference range. The indicator may be used to represent that an object located at an altitude of the virtual space different from the reference range is located at an altitude different from the reference range. The reference range may represent a virtual space extending from the reference location along the elevation direction.

According to an embodiment, when the one or more objects include a first object located at an altitude in the virtual space higher than the reference range, the mini-map may display a first indicator displayed with a second visual object corresponding to the first object. The first indicator may be used to represent that the first object is located at an altitude higher than the reference range. The reference range may represent a virtual space extending from the reference location along the elevation direction.

According to an embodiment, when the one or more objects include a second object located at an altitude in the virtual space lower than the reference range, the mini-map may display a second indicator displayed with a second visual object corresponding to the second object. The second indicator may be used to represent that the second object is located at an altitude lower than the reference range. The reference range may represent a virtual space extending from the reference location along the elevation direction.

According to an embodiment, the screen, in the second state of the mini-map, may further include an indicating bar representing a relative altitude of one or more objects corresponding to the one or more second visual objects and a third visual object including information of an object respectively corresponding to the second visual objects.

According to an embodiment, the processor may be configured to obtain an input on the mini-map. The processor may be configured to display, based on the input in a first area of the mini-map, a visually highlighted third visual object corresponding to an object located at an altitude in the virtual space higher than a reference range from among the plurality of objects. The processor may be configured to display, based on the input in a second area of the mini-map, a visually highlighted third visual object corresponding to an object located at an altitude in the virtual space lower than the reference range from among the plurality of objects. The processor may be configured to display, based on the input in a third area between the first area and the second area of the mini-map, a visually highlighted third visual object corresponding to an object located at an altitude in the virtual space in the reference range from among the plurality of objects. The reference range may represent a virtual space extending from the reference location along the elevation direction.

According to an embodiment, the indicating bar may include a first icon indicating that an object corresponding to a third visual object is located at an altitude in the virtual space higher than the reference range, a second icon indicating that an object corresponding to a third visual object is located at an altitude in the virtual space lower than the reference range, and a third icon indicating that an object corresponding to a third visual object is located at an altitude in the virtual space within the reference range. The processor may be configured to, while the third visual object corresponding to an object located at an altitude in the virtual space higher than the reference range is displayed in a visually highlighted state, activate the first icon. The processor may be configured to, while the third visual object corresponding to an object located at an altitude in the virtual space lower than the reference range is displayed in a visually highlighted state, activate the second icon. The processor may be configured to, while the third visual object corresponding to an object located at an altitude in the virtual space within the reference range is displayed in a visually highlighted state, activate the third icon.

According to an embodiment, the mini-map may include a first visual object indicating a reference location in the virtual space of the PC, one or more second visual objects indicating one or more objects associated with the PC, and an image of a display area of the virtual space identified based on the reference location. The screen, in the second state of the mini-map, may further include a slider bar representing a density of the one or more objects in accordance with an altitude.

According to an embodiment, the processor may be configured to display, when the density for a first altitude has a first density, a first segment of the slider bar corresponding to the first altitude with a first brightness. The processor may be configured to display, when the density for a second altitude has a second density higher than the first density, a second segment of the slider bar corresponding to the second altitude with a second brightness brighter than the first brightness.

According to an embodiment, the screen, in the second state of the mini-map, may further include a scroll view displaying information on an object in accordance with an altitude. The scroll view may be displayed adjacent to the slider bar. The processor may be configured to detect a swipe input from the second segment toward the first segment. The processor may be configured to change sequentially, according to the swipe input, from the scroll view including information on at least one object located at the second altitude to the scroll view including information on at least one object located at the first altitude.

According to an embodiment, the processor may be configured to, based on detecting release of the swipe input on the first segment, display the scroll view including a list of the at least one object located at the first altitude. The processor may be configured to change, according to a scroll input on the scroll view, information of an object included in the list.

According to an embodiment, the screen may further include a ball-shaped user interface (UI) located adjacent to the mini-map. The input may include a drag input on the UI.

According to an embodiment, the processor may be configured to detect a direction of the drag input obtained while the mini-map in the first state is displayed. The processor may be configured to, based on detecting that the direction of the drag input is a first drag direction, change the view point from the first view point to the second view point. The processor may be configured to, while the first view point is changed to the second view point, change an area of the virtual space displayed on the mini-map from the first part to the second part.

According to an embodiment, the processor may be configured to detect, based on the drag input facing the first drag direction, an angle at which the UI rotates. The processor may be configured to detect, based on the angle of a first value, the second view point changed by a first elevation angle from the first view point. The processor may be configured to detect, based on the angle of a second value greater than the first value, the second view point changed by a second elevation angle greater than the first elevation angle from the first view point.

According to an embodiment, the processor may be configured to detect a direction of another drag input obtained while the mini-map in the second state is displayed. The processor may be configured to, based on detecting that the direction of the other drag input is a second drag direction opposite to the first drag direction, change the view point from the second view point to the first view point. The processor may be configured to, while the second view point is changed to the first view point based on the other drag input, change an area of the virtual space displayed on the mini-map from the second part to the first part.

According to an embodiment, the input may include a drag input on the mini-map.

According to an embodiment, the first part may represent a two-dimensional plane of the virtual space facing the elevation direction. When the second direction is perpendicular to the first direction, the second part may represent a two-dimensional plane of the virtual space parallel to the elevation direction.

According to an embodiment, the processor may be configured to, based on detecting a specified input on the mini-map, display the screen including the mini-map zoomed in or out. The specified input may include a pinch-out gesture or a pinch-in gesture.

As described above, a method executed by an electronic device may comprise displaying, via a display, a screen including at least a part of a virtual space including a player character (PC) corresponding to a user of the electronic device. The screen may include a mini-map for representing the virtual space. The method may comprise displaying, in a first state of the mini-map, the mini-map including a first part of the virtual space viewed along a first direction parallel to an elevation direction of the virtual space, from a first view point above the PC. The method may comprise displaying, based on an input for changing a view point of the mini-map, in a second state changed from the first state, mini-map including a second part of the virtual space viewed along a second direction different from the first direction, from a second view point different from the first view point.

As describe above, in a computer-readable storage medium storing one or more programs, the one or more programs may comprise instructions which, when executed by a processor of an electronic device, cause the electronic device to display, via a display of the electronic device, a screen including at least a part of a virtual space including a player character (PC) corresponding to a user of the electronic device. The screen may include a mini-map for representing the virtual space. The one or more programs may comprise instructions which, when executed by the processor of the electronic device, cause the electronic device to display, in a first state of the mini-map, the mini-map including a first part of the virtual space viewed along a first direction parallel to an elevation direction of the virtual space, from a first view point above the PC. The one or more programs may comprise instructions which, when executed by the processor of the electronic device, cause the electronic device to display, based on an input for changing a view point of the mini-map, in a second state changed from the first state, mini-map including a second part of the virtual space viewed along a second direction different from the first direction, from a second view point different from the first view point.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later. According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is

1. An electronic device comprising:
a display;
at least one memory configured to store at least one program;
at least one processor configured to operate as instructed by the program, the program being configured to cause the at least one processor to:
display, on the display, a screen including at least a part of a virtual space and a mini-map for representing the virtual space, wherein the screen includes a player character (PC) corresponding to a user;
display the mini-map in a first state showing a first part of the virtual space as viewed from a first viewpoint above the PC along a first direction parallel to an elevation direction of the virtual space; and
display, based on an input for changing a viewpoint of the mini-map, the mini-map in a second state showing a second part of the virtual space as viewed from a second viewpoint along a second direction different from the first direction.

2. The electronic device of claim 1,
wherein the mini-map includes:
a first visual object indicating at least one reference location of the PC in the virtual space,
at least one second visual object indicating at least one object associated with the PC, and
an image of an area of the virtual space;
wherein the at least one first visual object and the at least one second visual object are displayed in a floated state with respect to the image; and
wherein the area includes the first part and the second part of the virtual space.

3. The electronic device of claim 2, wherein,
based on the at least one object associated with the PC, including an object located at an altitude different from a reference range, the mini-map displays an indicator with a second visual object corresponding to the object located at the altitude different from the reference range;
wherein the indicator indicates that the object is located at the altitude different from the reference range; and
wherein the reference range represents a spatial range extending from the reference location along the elevation direction.

4. The electronic device of claim 2, wherein the screen, based on the second state of the mini-map, further includes:
an indicating bar representing a relative altitude of at least one object corresponding to the at least one second visual object; and
at least one third visual object including information associated with the at least one object.

5. The electronic device of claim 4,
wherein the mini-map comprises a first area, a second area, and a third area between the first area and the second area;
wherein the program is further configured to cause the at least one processor to:
receive an input on the mini-map;
highlight visually, based on the input in the first area, a third visual object corresponding to a first object located at an altitude higher than a reference range from among a plurality of objects;
highlight visually, based on the input in the second area, a third visual object corresponding to a second object located at an altitude lower than the reference range; and
highlight visually, based on the input in the third area, a third visual object corresponding to a third object located at an altitude in the reference range.

6. The electronic device of claim 5, wherein the indicating bar includes:
a first icon associated with the first object;
a second icon associated with the second object; and
a third icon associated with the third object, and
wherein the program is further configured to cause the at least one processor to:
based on the third visual object corresponding to the first object, activate the first icon;
based on the third visual object corresponding to the second object, activate the second icon; and
based on the third visual object corresponding to the third object, activate the third icon.

7. The electronic device of claim 2, wherein the mini-map includes:
at least one first visual object indicating a reference location in the virtual space of the PC,
at least one second visual object indicating at least one object associated with the PC, and
an image of a display area of the virtual space identified based on the reference location; and
wherein the screen, based on the second state of the mini-map, further includes a slider bar representing a density of the at least one object associated with the PC.

8. The electronic device of claim 7, wherein the program is further configured to cause the at least one processor to:
display, based on the density for a first altitude having a first density, a first segment of the slider bar corresponding to the first altitude with a first brightness; and
display, based on the density for a second altitude having a second density higher than the first density, a second segment of the slider bar corresponding to the second altitude with a second brightness brighter than the first brightness.

9. The electronic device of claim 8, wherein the screen, in the second state of the mini-map, further includes a scroll view displaying information on an object in accordance with an altitude;
wherein the scroll view is displayed adjacent to the slider bar, and
wherein the program is further configured to cause the at least one processor to:
detect a swipe input from the second segment toward the first segment; and
change sequentially, based on the swipe input, from displaying information on at least one object located at the second altitude to the information on at least one object located at the first altitude.

10. The electronic device of claim 9, wherein the processor is configured to:
based on detecting release of the swipe input, display the scroll view including a list of the at least one object located at the first altitude; and
change, based on a scroll input on the scroll view, information of the at least one object included in the list.

11. The electronic device of claim 1, wherein the screen further includes a ball-shaped user interface (UI) located adjacent to the mini-map,
wherein the input includes a drag input on the UI, and
wherein the program is further configured to cause the at least one processor to:
detect a direction of the drag input obtained based on the mini-map in the first state being displayed;
based on a first drag direction, change the view point from the first view point to the second view point; and
based on the second view point, change an area of the virtual space displayed on the mini-map from the first part to the second part.

12. The electronic device of claim 11, wherein the program is further configured to cause the at least one processor to:
identify, based on the drag input facing the first drag direction, an angle at which the UI rotates;
identify, based on the angle of a first value, the second view point changed by a first elevation angle from the first view point; and
identify, based on the angle of a second value greater than the first value, the second view point changed by a second elevation angle greater than the first elevation angle from the first view point.

13. The electronic device of claim 1,
wherein the input includes a drag input on the mini-map.

14. The electronic device of claim 1, wherein the first part represents a two-dimensional plane of the virtual space facing the elevation direction; and
wherein, based on the second direction being perpendicular to the first direction, the second part represents a two-dimensional plane of the virtual space parallel to the elevation direction.

15. The electronic device of claim 1, wherein the program is further configured to cause the at least one processor to:
based on receiving a pinch-out gesture, display the screen including the mini-map zoomed in, or
based on receiving a pinch-in gesture, display the screen including the mini-map zoomed out.

16. A method executed by an electronic device, comprising:
displaying, on the at least one display, a screen including at least a part of a virtual space and a mini-map for representing the virtual space, wherein the screen includes a player character (PC) corresponding to a user;
displaying the mini-map in a first state showing a first part of the virtual space as viewed from a first viewpoint above the PC along a first direction parallel to an elevation direction of the virtual space; and
displaying, based on an input for changing a viewpoint of the mini-map, the mini-map in a second state showing a second part of the virtual space as viewed from a second viewpoint along a second direction different from the first direction.

17. The method of claim 16,
wherein the mini-map comprises:
at least one first visual object indicating at least one reference location of the PC in the virtual space,
at least one second visual object indicating at least one object associated with the PC, and
an image of an area of the virtual space;
wherein the at least one first visual object and the at least one second visual object are displayed in a floated state with respect to the image; and
wherein the area includes the first part and the second part of the virtual space.

18. The electronic device of claim 17,
based on the at least one object associated with the PC including an object located at an altitude different from a reference range, the mini-map displays an indicator with a second visual object corresponding to the object located at the altitude different from the reference range;
wherein the indicator indicates that the object is located at the altitude different from the reference range; and
wherein the reference range represents a spatial range extending from the reference location along the elevation direction.

19. The electronic device of claim 17, wherein the screen, based on the second state of the mini-map, further includes:
an indicating bar representing a relative altitude of at least one object corresponding to the at least one second visual object; and
at least one third visual object including information associated with the at least one object.

20. A computer-readable storage medium storing at least one programs, wherein the at least one programs comprise instructions which, when executed by a processor of an electronic device, cause the electronic device to:
display, on the at least one display, a screen including at least a part of a virtual space and a mini-map for representing the virtual space, wherein the screen includes a player character (PC) corresponding to a user;
display the mini-map in a first state showing a first part of the virtual space as viewed from a first viewpoint above the PC along a first direction parallel to an elevation direction of the virtual space; and
display, based on an input for changing a viewpoint of the mini-map, the mini-map in a second state showing a second part of the virtual space as viewed from a second viewpoint along a second direction different from the first direction.
